(19) United States
(12) Patent Application Publication
(10) Pub. No.: US 2005/0147863 A1
(43) Pub. Date: Jul. 7, 2005

(54) Fuel supply system for fuel cell system designed to ensure stability in regulating flow rate of recirculated off-gas

(75) Inventors: Hidehiko Hiramatsu, Kariya-shi (JP); Takeshi Yamamoto, Ama-gun (JP); Shingo Morishima, Toyota-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/969,947

(22) Filed: Oct. 22, 2004

(30) Foreign Application Priority Data
Oct. 22, 2003 (JP) 2003-362484

(51) Int. Cl. H01M 2/02

(52) U.S. Cl. 429/34

(57) ABSTRACT

A fuel supply system for use in a fuel cell system which includes a controller, a pressure regulator, and an ejector device. The controller controls the pressure of a main flow of fuel gas outputted from the pressure regulator and the position of an ejector nozzle of the ejector vacuum pump as a function of electricity generated by a fuel cell to adjust a flow rate of an off-gas to be recirculated to the fuel cell. This structure eliminates the need for an additional flow regulator to regulate the flow rate of the off-gas, thereby ensuring the stability in controlling the flow rate of the off-gas to be recirculated.

### CROSS-REFERENCE TO RELATED APPLICATION

The present application claims the benefit of Japanese Application No. 2003-362484, which was filed on Oct. 22, 2003, the disclosure of which is hereby incorporated by reference.

### BACKGROUND OF THE INVENTION

1 Technical Field of the Invention

The present invention relates generally to a fuel supply system working to mix a fuel gas discharged from a fuel cell (i.e., an off-gas) with a main supply of fuel stream and recirculate it to the fuel cell, and more particularly to such a fuel supply system designed to ensure the stability in regulating a flow rate of the off-gas to be recirculated.

2 Background Art

There are known fuel cell systems designed to suck the off-gas discharged from a fuel electrode of a fuel cell using a pump and mix it with a main supply of fuel gas for recirculating the off-gas to the fuel cell. The pump is usually implemented by an ejector vacuum pump equipped with an ejector nozzle since it is capable of employing fluid energy of the main supply of fuel gas for power saving.

Specifically, a typical fuel supply system, as employed in the above type of fuel cell systems, is designed to keep the pressure of the fuel gas supplied to the fuel cell at a given level by regulating the flow rate thereof while recirculating the off-gas to a fuel electrode of the fuel cell. Such pressure control of the fuel gas only by means of the regulation of the flow rate thereof, however, encounters a difficulty in controlling the flow rate of the off-gas to be recirculated to the fuel cell.

In order to avoid the above problem, Japanese Patent First Publication No. 9-213353 teaches use of a flow regulator in an off-gas recirculating line of a fuel supply system to control the flow rate of the off-gas to be recirculated. This system, however, encounters the drawback in that moisture created within the fuel cell flows into the off-gas recirculating line and may freeze, which results in a failure in operation of the flow regulator. Further, Japanese Patent First Publication No. 2001-266922 discloses a fuel supply system equipped with a pressure regulating valve for regulating the pressure of a main supply of fuel gas and a variably controllable flow rate ejector vacuum pump, but they are not for controlling the flow rate of the off-gas to be recirculated.

### SUMMARY OF THE INVENTION

It is therefore a principal object of the invention to avoid the disadvantages of the prior art.

It is another object of the invention to provide a fuel supply system designed to ensure the stability in regulating the flow rate of an off-gas to be recirculated to a fuel cell without encountering the above freeze problem.

According to one aspect of the invention, there is provided a fuel supply system for use in a fuel cell system which may be employed in automotive vehicles. The fuel supply system comprises: (a) a fuel supply line which feeds a main supply of fuel to a fuel cell from a fuel supply device; (b) a pressure regulator installed in the fuel supply line which works to regulate a pressure of the main supply of fuel; (c) an off-gas recirculating line joined to a portion of the fuel supply line downstream of the pressure regulator to recirculate an off-gas including fuel discharged from the fuel cell to the fuel cell through the fuel supply line; (d) an ejector device installed in a junction of the fuel supply line and the off-gas recirculating line, the ejector device including a nozzle having a variable open area from which a jet of the fuel supplied from the fuel supply line is emitted to create a vacuum pressure which works to suck the off-gas from the off-gas recirculating line to produce a fuel/off gas mixture made up of the fuel supplied from the fuel supply device and the off-gas which is, in turn, fed to the fuel cell; and (e) a controller working to control operations of the pressure regulator and the ejector device. The controller monitors a power generating condition of the fuel cell to control the pressure of the main supply of fuel, as regulated by the pressure regulator, and the open area of the nozzle of the ejector device to change a flow rate of the off-gas to be recirculated through the off-gas recirculating line.

The above structure eliminates the need for an additional flow regulator in the off-gas recirculating line, thus avoiding the freeze problem experienced by the conventional structure, as discussed in the introductory part of this application. Use of the map, as illustrated in FIG. 3, which represents the pressure of the main supply fuel and the open area of the nozzle of the ejector device facilitates ease with which the flow rate of the off-gas to be recirculated is controlled as a function of a load on operation of the fuel cell.

In the preferred mode of the invention, when the voltage developed by the fuel cell drops below a given levels the controller controls the operations of the pressure regulator and the ejector device to increase the flow rate of the off-gas to be recirculated. For example, when a fuel electrode of the fuel cell is flooded, that is, when water stays in a gas flow path in the fuel supply system, thereby resulting in instability of power generation in the fuel cell, it will cause the cell voltage of the fuel cell to drop. When detecting such a voltage drop, the controller may increase the flow rate of the off-gas to be recirculated in the off-gas recirculating line temporarily to elevate the flow velocity of the fuel gas in the gas flow path, thereby purging the gas flow path of the water. The flow rate of the off-gas to be recirculated may be increased stepwise for a given period of time or continuously until the cell voltage returns to a desired level.

The fuel supply system may also include a humidify sensor which is installed in a portion of the fuel supply line located downstream of the ejector device and works to measure a humidify of the fuel/off gas mixture flowing through the portion of the fuel supply line. The controller may control the flow rate of the off-gas to be recirculated as a function of the humidify, as measured by the humidify sensor, to achieve an amount of moisture required to be added to the fuel cell which may be determined as a function of a power generating condition of the fuel cell.

The fuel supply system may alternatively include a humidify sensor which is installed in the off-gas recirculating line and works to measure a humidify of the off-gas flowing through the off-gas recirculating line. The controller may control the flow rate of the off-gas to be recirculated as a function of the humidify, as measured by the humidify sensor, to achieve the humidify of the fuel/off gas mixture matching with the amount of moisture required to be added to the fuel cell.

The fuel supply system may alternatively include a temperature sensor which is installed in the off-gas recirculating line and works to measure a temperature of the off-gas flowing through the off-gas recirculating line. The controller may determine the humidify of the off-gas as a function of the temperature thereof and control the flow rate of the off-gas to be recirculated to regulate a mixing ratio of the main supply of fuel to the off-gas which achieves the amount of moisture required to be added to the fuel.

The fuel supply system may alternatively include a hydrogen concentration sensor which is installed in a portion of the fuel supply line located downstream of the ejector device and works to measure a concentration of hydrogen contained in the fuel/off gas mixture flowing through the portion of the fuel supply line. The controller may control the flow rate of the off-gas to be recirculated as a function of the concentration of hydrogen, as measured by the hydrogen concentration sensor, to achieve a hydrogen stoichiometric flow ratio required by the fuel cell. The hydrogen stoichiometric flow ratio may be determined based on the power generating condition of the fuel cell.

The fuel supply system may alternatively include a hydrogen concentration sensor which is installed in the off-gas recirculating line and works to measure the concentration of hydrogen contained in the off-gas. The controller may control the flow rate of the off-gas to be recirculated as a function of the concentration of hydrogen, as measured by the hydrogen concentration sensor, to achieve the hydrogen stoichiometric flow ratio required by the fuel cell.

### BRIEF DESCRIPTION OF THE DRAWINGS

The present invention will be understood more filly from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit diagram which shows a fuel cell system equipped with a fuel supply system according to the fist embodiment of the invention;

FIG. 2 is a longitudinal sectional view which shows an ejector vacuum pump used in the fuel supply system of FIG. 1;

FIG. 3 is a map which represents a relation between a hydrogen supply pressure and a flow rate of a recirculated off-gas in tens of an open area of a nozzle of an ejector vacuum pump for modifying the flow rate of the recirculated off-gas;

FIG. 4 is a block diagram which shows a fuel supply system according to the second embodiment of the invention;

FIG. 5 is a block diagram which shows a fuel supply system according to the third embodiment of the invention;

FIG. 6 is a block diagram which shows a fuel supply system according to the fourth embodiment of the invention;

FIG. 7 is a map for use in determining a flow rate off-gas required to be recirculated in terms of the temperature of the off-gas and the amount of moisture to be added to a fuel cell;

FIG. 8 is a block diagram which shows a fuel supply system according to the fifth embodiment of the invention;

FIG. 9 is a map for use in determining the concentration of hydrogen required by a fuel cell in terms of a hydrogen stoichiometric flow ratio;

FIG. 10 is a flowchart of a program executed by a controller in the fuel supply system of FIG. 8;

FIG. 11 is a block diagram which shows a fuel supply system according to the sixth embodiment of the invention;

FIG. 12 is a map for use in determining the flow rate of off-gas required to be recirculated in terms of a required hydrogen stoichiometric flow ratio and the concentration of the off-gas;

FIG. 13 is a flowchart of a program executed by a controller in the fuel supply system of FIG. 11.

### DESCRIPTION OF THE PREFERRED EMBODIMENTS

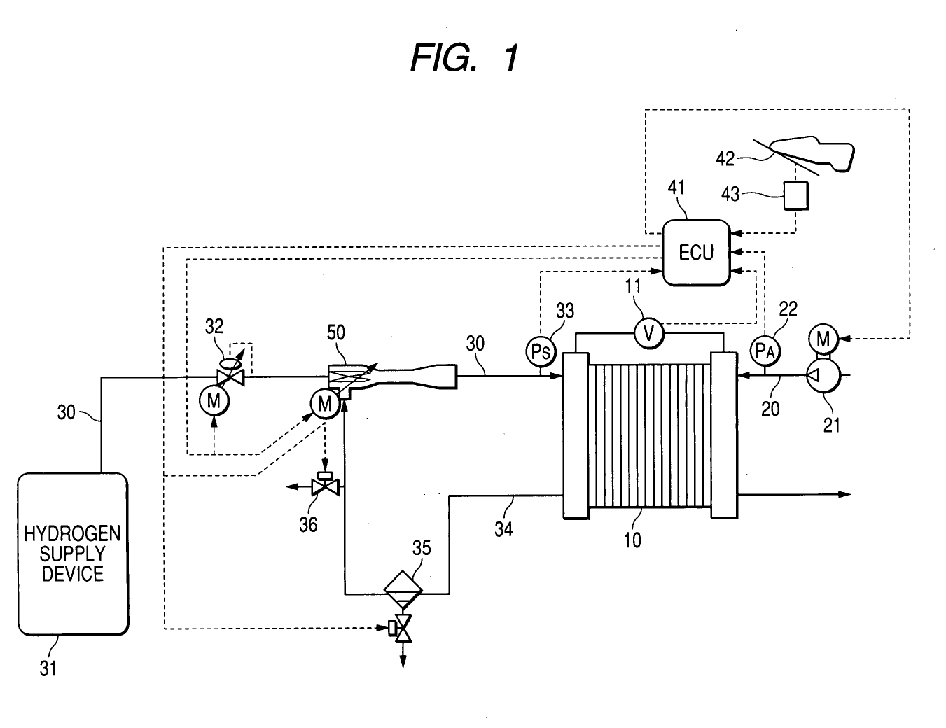

Referring to the drawings, wherein like reference numbers refer to like parts in several views, particularly to FIG. 1, there is shown a fuel cell system equipped with a fuel supply system according to the first embodiment of the invention which is employed in an electric automobile driven by fuel cells. The fuel cell system consists essentially of a fuel cell stack 10, an air supply device 21, a fuel supply device 31, an ejector device 50, and a controller 41. The ejector device 50 may be implemented by an ejector vacuum pump and will be referred to as an ejector vacuum pump 50 below.

The fuel cell stack 10 works to convert the energy produced by electrochemical reaction of hydrogen (i.e., fuel) and oxygen (i.e., oxidizing agent) into electric power. The fuel cell stack 10 is made up of a plurality of solid polyelectrolyte fuel cells (PEFCs). Each cell is made up of a pair of electrodes (will also called an oxygen and a fuel electrode below) and an electrolyte film disposed between the electrodes. The fuel cell stack 10 is used to supply the power to an electrical device such as a drive motor or a storage battery. The fuel cell stack 10 is provided with a voltage sensor 11 which measures the voltage developed across the fuel cell stack 10 and output a signal indicative thereof to the controller 41. The fuel cell stack 10 is supplied with hydrogen and air (oxygen) and induces electrochemical reactions thereof at the electrodes which are of the forms:
Hydrogen electrode H2→2H⁺+2e⁻+Q (heat developed)
Oxygen electrode 1/2O₂+2H⁺+2e⁻→H₂O+Q

The above electrochemical reactions produce water. Additionally, humidified hydrogen and air gasses supplied into the fuel cell stack 10 will cause condensed water to be produced therein. The moisture is, thus, produced within the fuel cell stack 10.

The fuel cell system also has an air supply line 20 for supplying oxygen-containing air to the oxygen electrodes (i.e., positive electrodes) of the fuel cell stack 10 and a hydrogen supply line 30 for supplying hydrogen gas to the hydrogen electrodes (i.e., negative electrodes) of the fuel cell stack 10. An air supply device 21 is disposed at the most upstream side of the air supply line 20. A hydrogen supply device 31 is disposed at the most upstream side of the fuel supply line 30. The air supply device 21 is implemented by a compressor. The hydrogen supply device 31 is implemented by a high-pressure hydrogen tank filled with the hydrogen gas.

The fuel cell system also includes a pressure regulator 32 which is installed in the hydrogen supply line and works to regulate the amount and pressure of hydrogen gas supplied from the hydrogen supply device 31. The fuel cell system further includes an air supply pressure sensor 22 and a hydrogen supply pressure sensor 33. The air supply pressure sensor 22 is installed in the air supply line 20 near an air inlet of the fuel cell stack 10 and works to measure the pressure of air supplied to the fuel cell stack 10. The hydrogen supply pressure sensor 33 is installed in the hydrogen supply line 30 near a hydrogen gas inlet of the fuel cell stack 10 and works to measure the pressure of hydrogen gas supplied to the fuel cell stack 10. The pressure of hydrogen gas supplied to the fuel cell stack 10 is substantially equal to an output pressure of the ejector vacuum pump 50.

An off-gas recirculating line 34 extends between a hydrogen outlet of the fuel cell stack 10 and a portion of the hydrogen supply line 30 located downstream of the pressure regulator 32. The off-gas recirculating line 34 works to combine an off-gas which contains an unreacted hydrogen gas discharged from the fuel cell stack 10 with a main flow of the hydrogen gas supplied to the fuel cell stack 10.

The off-gas recirculating line 34 has disposed therein an gas-liquid separator 35 and a drain valve 36. The gas-liquid separator 35 works to separate water from the off-gas. The drain valve 36 works to discharge the off-gas outside the fuel cell system. The water separated by the gas-liquid separator 35 is drained by opening a drain valve installed beneath the gas-liquid separator 35, as viewed in the drawing.

The ejector vacuum pump SO is installed at a junction of the off-gas recirculating line 34 and the hydrogen supply line 30. The ejector vacuum pump 50, as will be described later in detail, works to suck therein the off-gas using fluid energy developed by a flow of the hydrogen gas outputted from the fuel supply device 31 and recirculate the off-gas to the fuel cell stack 10.

The fuel cell system, as described above, has the controller 41 implemented by an electronic control unit (ECU). The controller 41 receives an output signal of an accelerator position sensor 43 indicating a position of an accelerator pedal 42 of the automotive vehicle and calculates the amount of electricity required to be generated by the fuel cell stack 10 based on the position of the accelerator pedal 42. The controller 41 also works to calculate amounts of the hydrogen gas and the off-gas and a supply pressure of the hydrogen gas (i.e., the output pressure of the ejector vacuum pump 50) needed for the fuel cell stack 10 to generate a required amount of electricity.

The controller 41 also calculates the amount of air required for the fuel cell stack 10 to generate the required amount of electricity and control the speed of the air supply device 21 (i.e., the speed of the compressor). Specifically, the controller 41 monitors an output of the air supply pressure sensor 22 to modify the speed of the air supply device 21 under feedback control. The controller 41 also controls the generation of electricity in the fuel cell stack 10 based on an output of the voltage sensor 11.

The controller 41 also receives an output of the hydrogen supply pressure sensor 33 and calculates a target valve open position of the pressure regulator 32 based on the amount of hydrogen gas required to be supplied and a nozzle open position of the ejector vacuum pump 50 based on the amount of off-gas required to be recirculated and outputs control signals to the pressure regulator 32 and the ejector vacuum pump 50. The controller 41 also output control signals to valves installed in the gas-liquid separator 35 and the drain valve 36.

The ejector vacuum pump 50, as clearly shown in Wig. 2, consists essentially of a nozzle unit 51, a pipe unit 52, and a drive unit 52 which are assembled independently and then joined together to complete the ejector vacuum pump 50.

The nozzle unit 51 includes a nozzle body 511 and a needle 512. The nozzle body 511 and the needle 512 are made of a metallic such as SUS316L or SUS304L which is high in corrosion and erosion resistance. The needle 512 is also treated with a DLC (diamond like carbon) in order to improve slidability and wear resistance thereof.

The nozzle body 511 is substantially cylindrical and includes a cylindrical guide hole 51 11, a cylindrical main flow path 5112, and a nozzle 5113 which are aligned with a length or axis of the nozzle body 511. The guide hole 5111 works to retain the needle 512 slidably therein. The main flow path 5112 is smaller in diameter than the guide hole 5111 and communicates between a main flow inlet port, as described later, and the nozzle 5113. The nozzle 5113 has a tapered outer wall.

The nozzle body 511 has formed in a middle portion thereof the main flow inlet port 5114 which leads to the main flow path 5112. The main flow inlet port 5114 connects with the hydrogen supply line 30 to introduce the hydrogen gas discharged from the hydrogen supply device 31 thereinto. The main flow path 5112 communicates with the guide hole 5111 and the main flow inlet port 5114 through an inlet defined by a chamfered annular edge 5115 formed in the nozzle body 511. The chamfered edge 5115 serves as a sealing surface which forms a seal when the main flow path 5112 is closed by the needle S52. The needle 512 is made of a cylindrical bar which has a large-diameter portion 5121 placed to be slidable within the guide hole 5111.

The needle 512 also includes a first small-diameter portion 5122 and a second small-diameter portion 5124 which are smaller in diameter than the large-diameter portion 5121. The first small-diameter portion 5122 extends from the large-diameter portion 5121 to inside the nozzle S515. The first small-diameter portion 5122 has a tapered head 5123 for regulating an open area of the nozzle 5113.

The second small-diameter portion 5124 extends from the large-diameter portion 5124 in alignment with the first small-diameter portion 5122. The large-diameter portion 5121 has a chamfered edge defining a sealing surface 5125 which forms a seal when the sealing surface 5125 abuts with the nozzle body-side sealing surface 5115 to close the main flow path 5112. The nozzle unit 51 is so designed in dimension as to avoid a physical collision of the tapered head 5123 with the nozzle 5113 when the needle-side sealing surface 5125 is placed in abutment with the nozzle body-side sealing surface 5115.

The pipe unit 52 is joined to an end of the nozzle body 511 of the nozzle unit 51 close to the nozzle 5113. The pipe unit 51 is substantially cylindrical and includes a discharge path 521 extending along a longitudinal center line (i.e., an axial direction) thereof. The nozzle 5113 is inserted into an upstream end of the discharge path 521. The discharge path 521 connects at a downstream end thereof with the fuel cell stack 10 through the hydrogen supply line 30. The pipe unit 51 also has a suction port 522 formed in a middle portion thereof which leads to the discharge path 521. The suction part 522 connects with the off-gas recirculating line 34.

The drive unit 53 works to control movement of the needle 512 of the nozzle unit 51 and is joined to an end of the nozzle body 511 remote from the nozzle 5113. The drive unit 53 is implemented by a stepper motor and consists of a rotor 531, a stator 532, a shield 533, and a needle guide 534.

The needle guide 534 is fixed at an end thereof in the nozzle body 511 and retains the second small-diameter portion 5124 of the needle 512 slidably. The second small-diameter portion 5124 of the needle 512 has a tip end joined to the rotor 531. The rotor 531 has an internal thread 5321 meshing with an external thread 5341 of the needle guide 534 so that rotation of the rotor 531 will cause the rotor 531 and the needle 512 to move in an axial direction thereof.

In operation of the fuel cell system, when it is required to consume the hydrogen gas in the fuel cell stack 10, the hydrogen supply device 31 works to supply the hydrogen gas to the fuel cell stack 10 through the hydrogen supply line 30 and the ejector vacuum pump 50. Upon entering the ejector vacuum pump 50, the hydrogen gas is discharged from the nozzle 5113 in the form of a main gas jet

When the hydrogen gas passes through the ejector vacuum pump 50, the fluid energy thereof creates the kinetic energy (i.e., vacuum) for recirculation of the off-gas. Specifically, when the main gas jet flows through the discharge path 521, it creates a vacuum pressure around an outer periphery of the nozzle 5113 to suck the off-gas from the off-gas recirculating line 34 through the suction port 522 and mix it with the main gas jet.

The ejector vacuum pump 50 has the name 5113 working to convert the pressure energy of the hydrogen gas into speed energy which reduces the pressure of and expands the main gas jet entropically, a suction path 52a working to suck the off-gas from the off-gas recirculating line 34 through the vacuum created by the main jet of the hydrogen gas from the nozzle 5113, a mixing port 52b wording to mix the mainjet of the hydrogen gas from the nozzle 5113 with a sucked flow of the off-gas, and a diffuser 52c working to convert the speed energy of the mixture into the pressure energy thereof, thereby elevating the pressure of the mixture.

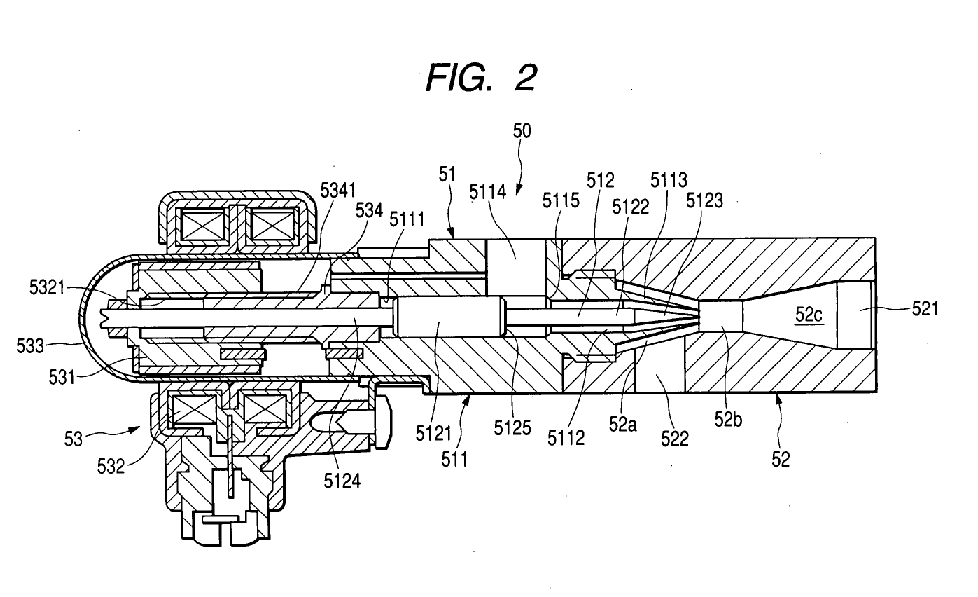

The mixing port 52b works to mix the drive flow (i.e., the main jet of the hydrogen gas) and the sucked flow of the off-gas together while conserving the sum of kinetic momentums of the drive flow and the sucked flow, thus resulting in an elevation in static pressure of the mixture in the mixing port 52b. The diffuser 52c, as can be seen from FIG. 2, has a flow path whose sectional area increases gradually toward an outlet of the discharge path 521 and functions to convert the speed energy (i.e., dynamic pressure) of the mixture into the pressure energy (i.e., static pressure) thereof as the mixture flows through the increasing sectional area of the flow path. Specifically, both the mixing port 52b and the diffuser 52c work to increase the pressure of the mixture. An assembly of the mixing port 52b and the diffuser 52c work as a booster.

In order to increase the velocity of a jet of hydrogen gas from the nozzle 5113 above the velocity of sound, the ejector vacuum pump 50 may alternatively use a Laval nozzle (also called a convergent-divergent nozzle) which has a throat (i.e., the smallest cross-section) in a middle of a nozzle path (see Fluidics published by the University of Tokyo Press). The mixture of the hydrogen gas and the off-gas produced in the discharge path 521 is fed to the fuel cell stack 10 through the hydrogen supply line 30.

The adjustment of the amount or flow rate of hydrogen gas jet out of the nozzle 5113 is achieved by actuating the drive unit 53 to move the nozzle 512 linearly in the axial direction of the ejector vacuum pump 50 to change an open area of the nozzle 5113. When it becomes unnecessary to consume the hydrogen gas in the fuel cell stack 10, the drive unit 53 is turned on to move the needle 512 until the needle-side sealing surface 5125 abuts the nozzle body-side sealing surface 5115 to close the main flow path 5112.

The feature of this embodiment will be described below.

The pressure regulator 32 works to regulate the pressure of the hydrogen gas to be supplied to the ejector vacuum pump 50 (which will also be referred to as a main hydrogen supply pressure below). The ejector vacuum pump 50, as described above, works to control the position of the nozzle 5113 (i.e., an open sectional area of the nozzle 5113) to adjust the flow rate of the hydrogen gas to be supplied to the fuel cell stack 10 (which will also be referred to a main hydrogen supply flow rate below) to a target one.

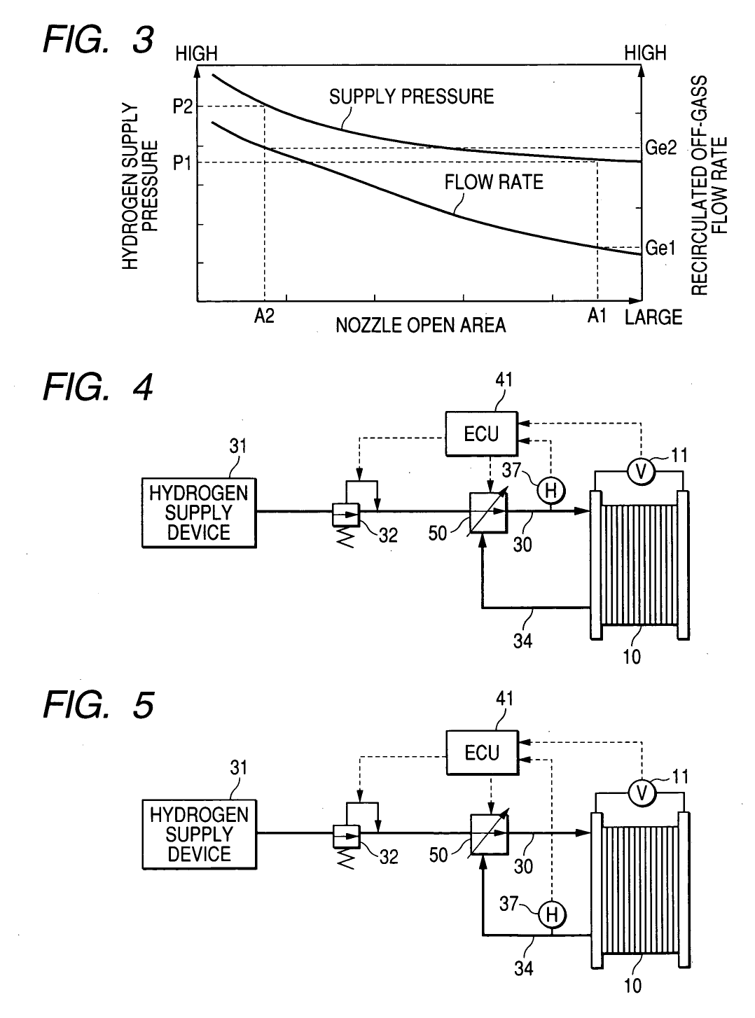

The controller 41 calculates the main hydrogen supply flow rate which meets a required electrical load on the fuel cell stack 10 and determines a nozzle position of the ejector vacuum pump 50 and an outlet pressure of the pressure regulator 32 (i.e., an inlet pressure of the ejector vacuum pump 50) which are required to establish the calculated main hydrogen supply flow ate. Subsequently, the controller 41 monitors a power generating condition of the fuel cell stack 10 (e.g., a power generating history, a cell voltage, or a current density distribution which may be determined using a known density distribution sensor) and determines a target flow rate of the off-gas required to be recirculated through the off-gas recirculating line 34 based on the monitored power generating condition. Finally, the controller 41 determines the nozzle position of the ejector vacuum pump 50 and the outlet pressure of the pressure regulator 32 which are required to achieve the target flow rate of the off-gas while keeping the calculated main hydrogen supply flow rate constant and changes the nozzle position of the ejector vacuum pump 50 and the outlet pressure of the pressure regulator 32 simultaneously to control only the flow rate of the off-gas to be recirculated through the off-gas recirculating line 34 (which will also be referred to as a recirculated off-gas flow rate Ge below) to bring the recirculated off-gas flow rate Ge into agreement with the target one. This eliminates the need for installation of an additional flow rate control valve in the off-gas recirculating line 34, thereby alleviating a freezing problem therein. The controller 41 may use a map, as shown in FIG. 3, which represents a relation between the hydrogen supply pressure, as determined by the pressure regulator 32, and the recirculated off-gas flow rate Ge, as determined by the position of the nozzle 5113 (i.e., a nozzle open area) of the ejector vacuum pump 50, to adjust the recirculated of-gas flow rate Ge to a desired one.

In an example, as illustrated in FIG. 3, when it is required to increase the recirculated off-gas flow rate Ge from Ge1 to Ge2, the controller 41 actuates the drive unit 53 of the ejector vacuum nozzle 50 to decrease the nozzle open area from AI to A2 and, at the same time, controls the pressure regulator 32 to increase the main hydrogen supply pressure from P1 to P2. This changes the recirculated off-gas flow rate Ge without any change in the main hydrogen supply flow rate.

When the voltage V developed by the fuel cell stack 10 drops below a given reference level, the controller 41 performs the above operation to increase the recirculated off-gas flow rate Ge. For instance, when the fuel electrodes of the fuel cell stack 10 are flooded, that is, when water is produced and stays in the gas flow path, thereby resulting in instability of power generation in the fuel cell stack 10, it will cause the cell voltage of the fuel cell stack 10 to drop. When such a voltage drop arises, the controller 41 increases the recirculated off-gas flow rate Ge in the off-gas recirculating line 34 temporarily to elevate the flow velocity of fuel gas in the gas flow path, thereby purging the gas flow path of the water. The recirculated off-gas flow rate Ge may be increased stepwise for a desired level.

FIG. 4 shows a fuel supply system according to the second embodiment of the invention. The fuel supply system includes a humidity sensor 37 which measures the humidity H of the mixture of the hydrogen gas and the off-gas flowing through a portion of the hydrogen supply line 30 downstream of the ejector vacuum pump 50. The controller 41 works to control the recirculated off-gas flow rate Ge as a function of the humidity H, as measured by the humidity sensor 37, to bring the humidity H into agreement with a target humidity Hn required by the fuel cell stack 10 (i.e., the amount of moisture to be added to the fuel cell stack 10).

The required humidity Hn depends upon a power generating condition (e.g., the generated current) of the fuel cell stack 10. The controller 41 determines the required humidity Hn and controls the amount of the off-gas containing moisture to adjust the humidity H, as measured by the humidity sensor 37, to the required humidity Hn. Other arrangements and operations of the fuel supply system are identical with those in the first embodiment, and explanation thereof in detail will be omitted here.

FIG. 5 shows a fuel supply system according to the third embodiment of the invention which is different from that of the second embodiment in location of the humidity sensor 37.

The humidity sensor 37 is installed in the off-gas recirculating line 34 to measure the humidity H of the off-gas being recirculated. The controller 41 monitors an output of the humidity sensor 37 to determine a hydrogen/off-gas mixture ratio necessary to match the humidity H in the off-gas recirculating line 34 with the lo humidity Hn required by the fuel cell stack 10 and controls the recirculated off-gas flow rate Ge. Other arrangements and operations of the fuel supply stem are identical with those in the second embodiment, and explanation thereof in detail will be omitted here.

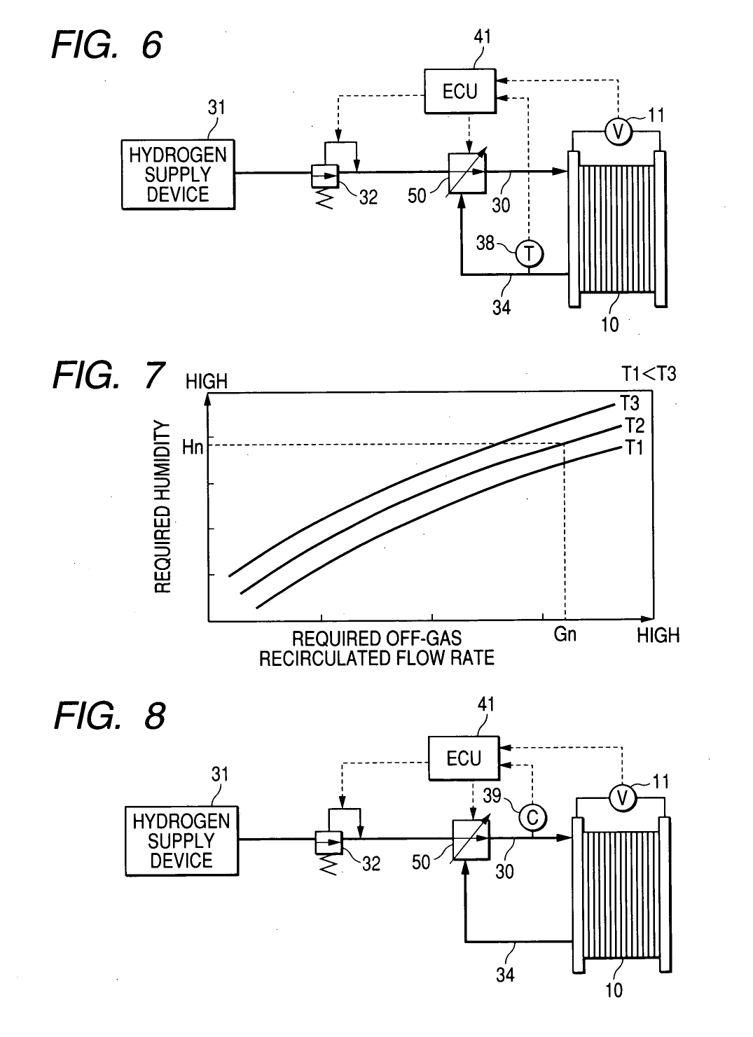

FIG. 6 shows a fuel supply system according to the fourth embodiment of the invention which is different from the above embodiments in that a temperature sensor 38 is installed in the off-gas recirculating line 34 to measure the temperature T of the off-gas, and the controller 41 controls the recirculated off-gas flow rate Ge as a function of the temperature T to bring the humidity of the B e supplied to the fuel cell stack 10 into agreement with the required humidity Hn.

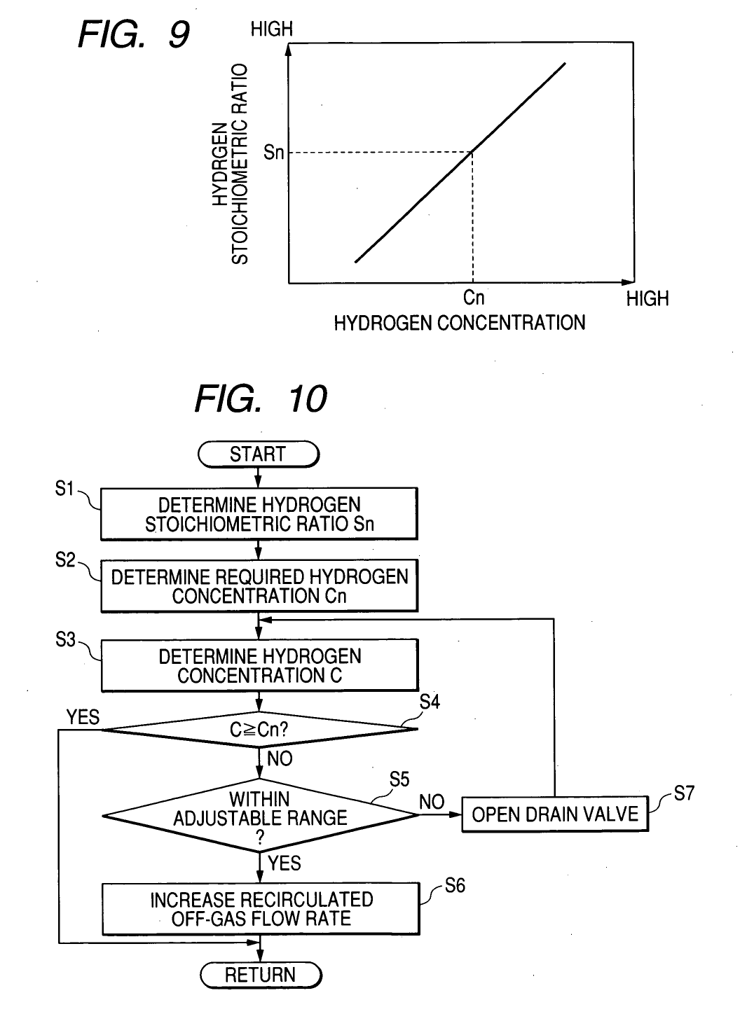

Specifically, the controller 41 monitors an output of the temperature sensor 38 to measure the temperature T of the off-gas, calculates a corresponding saturated vapor pressure, and determines a vapor concentration as a function of the pressure of the off-gas and the saturated vapor pressure. For instance, when the temperature T of the off-gas is 50° C., the saturated vapor pressure will be approximately: 18 kPa When the pressure of the off-gas is 200 kpa.abs, the vapor concentration may be determined as 18/200 assuming that the humidity is 100%. Next, the controller 4,1 determines the recirculated off-gas flow rate Ge based on the vapor concentration and the required humidity Hn and controls the nozzle open area of the ejector vacuum pump 50 and the pressure regulator 32 to regulate the recirculated off-gas flow rate Ge. More specifically, the controller 41 determines the amount of the off-gas required to be recirculated through the off-gas recirculating line 34 (will also be referred to as a required off-gas flow rate Gn below) based on the temperature T of the off-gas and the amount of moisture required to be supplied to the fuel cell stack 10 (i.e., the required humidity Hn), as determined as a function of the electricity generated by the fuel cell stack 10 by look-up using a map, as illustrated in FIG. 7, and controls the recirculated off-gas flow rate Ge so as to bring it into agreement with the required off-gas flow rate FIG. 8 shows a fuel supply system according to the fifth embodiment of the invention. FIG. 9 is a map for use in regulating the amount of the off-gas to be recirculated to the fuel cell stack 10.

The fuel supply system of this embodiment is different from those in the above embodiments in that a hydrogen concentration sensor 39 is installed in a portion of the hydrogen supply line 30 located downstream of the ejector vacuum pump 50 to measure the concentration of hydrogen contained in the hydrogen-off gas mixture (which will also be referred to as a hydrogen concentration C below), and the controller 41 controls the recirculated off-gas flow rate Ge so as to achieve a hydrogen stoichiometric flow ratio Sn required by the fuel cell stack 10.

The controller 41 monitors the power generation in the fuel cell stack 10 to determine the hydrogen stoichiometric flow ratio Sn (i.e., (the sum of the main hydrogen, supply flow rate (i.e., a flow rate of hydrogen gas discharged from inside the nozzle 5113 of the ejector vacuum pump 50) and a flow rate of hydrogen gas in the off-gas recirculated)/a flow rate of hydrogen gas required to be consumed in the fuel cell stack 10) and control the recirculated off-gas flow rate Ge so as to supply the hydrogen-off gas mixture to the fuel cell stack 10 which has the hydrogen concentration C matching the hydrogen stoichiometric flow ratio Sn.

FIG. 10 shows a flowchart of a sequence of logical steps or program to be executed by the controller 41 to control the recirculated off-gas flow rate Ge.

After entering the program, the routine proceeds to step 1 wherein the required hydrogen stoichiometric flow ratio Sn is determined based on the electricity (e.g., the current) being generated by the fuel cell stack 10.

The routine proceeds to step 2 wherein the concentration of hydrogen gas required by the fuel cell stack 10 (which will also be referred to as a required hydrogen concentration Cn below) is determined as a function of the required hydrogen stoichiometric flow ratio Sn by look-up using the map, as illustrated in FIG. 9, representing a relation between the required hydrogen stoichiometric flow ratio Sn and the hydrogen concentration C.

The routine proceeds to step 3 wherein an output of the hydrogen concentration sensor 39 is monitored to determine the hydrogen concentration C (i.e., the concentration of hydrogen in the hydrogen-off gas mixture supplied to the fuel cell stack 10).

The routine proceeds to step 4 wherein it is determined whether the hydrogen concentration C, as derived in step 3, is greater than or equal to the required hydrogen concentration Cn, as derived in step 2, or not.

If a NO answer is obtained in step 4 meaning that the hydrogen concentration C, as measured by the hydrogen concentration sensor 39, is lower than the required hydrogen concentration Cn, then the routine proceeds to step 5 wherein it is determined whether the pressure regulator 32 and the ejector vacuum pump 50 lie in a given flow rate adjustable range or not, that is, whether they still have capacities to increase the recirculated off-gas flow rate Ge further or not. If a YES answer is obtained, then the routine proceeds to step 6 wherein the controller 41 controls the pressure regulator 32 and the ejector vacuum pump 50 in the manner, as described above, to increase the recirculated off-gas flow rate Ge and returns back to step 1.

Alternatively, if a NO answer is obtained in step 5 meaning that the pressure regulator 32 and the ejector vacuum pump 50 do not have capacities to increase the recirculated off-gas flow rate Ge further, then the routine proceeds to step 7 wherein the drain valve 36 in the off-gas recirculating line 34 is opened for a given short period of time to drain the off-gas, thereby increasing the hydrogen concentration C in the off-gas recirculating line 34.

After step 7, the routine returns back to step 3. Specifically, the pressure regulator 32 and the ejector vacuum pump 50 are actuated to increase the recirculated off-gas flow rate Ge or alternatively the drain valve 36 is opened to increase the hydrogen concentration C repeatedly until the hydrogen concentration C exceeds the required hydrogen concentration Cn.

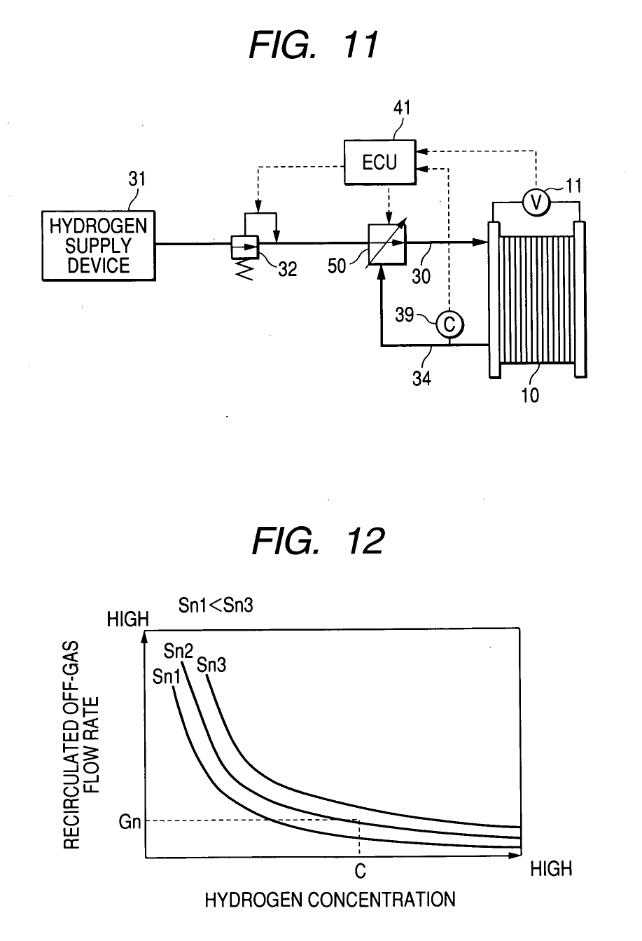

FIG. 11 shows a fuel supply system according to the sixth embodiment of the invention. FIG. 12 is a map, as used in regulating the amount of the off-gas to be recirculated to the fuel cell stack 10.

The fuel supply system of this embodiment is different from the one of FIG. 8 in that the hydrogen concentration sensor 39 is installed in the off-gas recirculating line 34.

The controller 41 controls the recirculated off-gas flow rate Ge based on the hydrogen concentration C, as measured by the hydrogen concentration sensor 39, so as to achieve the hydrogen stoichiometric flow ratio Sn required by the fuel cell stack 10.

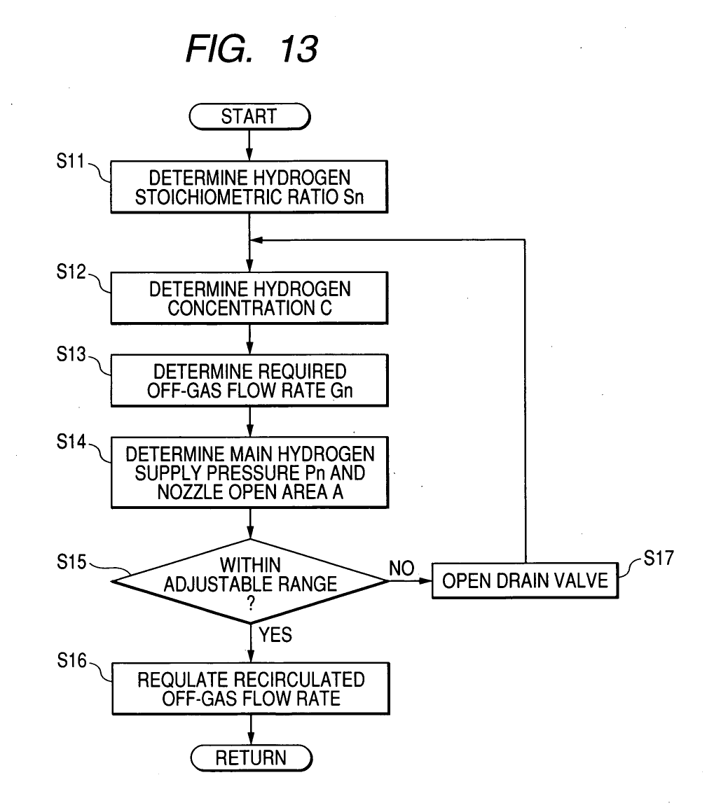

FIG. 13 shows a flowchart of a sequence of logical steps or program to be executed by the controller 41 to control the recirculated off-gas flow rate Ge.

After entering the program, the routine proceeds to step 11 wherein the required hydrogen stoichiometric flow ratio Sn is determined based on the electricity being generated by the fuel cell stack 10.

The routine proceeds to step 12 wherein an output of the hydrogen concentration sensor 39 is monitored to determine the hydrogen concentration C (i.e., the concentration of hydrogen in the off-gas).

The routine proceeds to step 13 wherein the required off-gas flow rate Gn is determined based on the required hydrogen stoichiometric flow ratio Sn, as derived in step 11, and the hydrogen concentration C of the off-gas, as determined in step 12, by look-up using the map, as illustrated in FIG. 12.

The routine proceeds to step 14 wherein the main hydrogen supply pressure Pn and the open sectional area A of the nozzle 5113 of the ejector vacuum pump 50 required to develop the required off-gas flow rate Gn is determined.

The routine proceeds to step 15 wherein it is determined whether the main hydrogen supply pressure Pn and the open sectional area A lie within capacity ranges of the pressure regulator 32 and the ejector vacuum pump 50 or not, that is, whether the pressure regulator 32 and the ejector vacuum pump 50 now have capacities to achieve the main hydrogen supply pressure Pn and the open sectional area A or not

If a YES answer is obtained, then the routine proceeds to step 16 wherein the controller 41 controls the pressure regulator 32 and the ejector vacuum pump 50 in the manner, as described above, to increase the recirculated off-gas flow rate Ge and returns back to step 1.

Alternatively, if a NO answer is obtained in step 15 meaning that the pressure regulator 32 and the ejector vacuum pump 50 do not have capacities to achieve the main hydrogen supply pressure Pn and the open sectional area A, then the routine proceeds to step 17 wherein the drain valve 36 in the off-gas recirculating line 34 is opened for a given short period of time to drain the off-gas, thereby increasing the hydrogen concentration C in the off-gas recirculating line 34. After step 17, the routine returns back to step 12.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch cam be embodied without departing from the principle of the invention as set forth in the appended claims.

1. A fuel supply system for a fuel cell comprising:
a fuel supply line which feeds a main supply of fuel to a fuel cell from a fuel supply device;
a pressure regulator installed in said fuel supply line which works to regulate a pressure of the main supply of fuel;
an off-gas recirculating line joined to a portion of said fuel supply line downstream of said pressure regulator to recirculate an off-gas including fuel discharged from the fuel cell to said fuel cell through said fuel supply line;
an ejector device installed in a junction of said fuel supply line and said off-gas recirculating line, said ejector device including a nozzle having a variable open area from which a jet of the fuel supplied from the fuel supply line is emitted to create a vacuum pressure which works to suck the off-gas from the off-gas recirculating line to produce a fuel/off gas mixture made up of the fuel supplied from the fuel supply device and the off-gas which is, in turn, fed to the fuel cell; and
a controller working to control operations of said pressure regulator and said ejector device, said controller monitoring a power generating condition of the fuel cell to control the pressure of the main supply of fuel, as regulated by said pressure regulator, and the open area of the nozzle of said ejector device to change a flow rate of the off-gas to be recirculated through said off-gas recirculating line.

2. A fuel supply system as set forth in claim 1, wherein when a voltage developed by the fuel cell drops below a given level, said controller controls the operations of said pressure regulator and said ejector device to increase the flow rate of the off-gas to be recirculated.

3. A fuel supply system as set forth in claim 1, faker comprising a humidify sensor which is installed in a portion of said fuel supply line located downstream of said ejector device and works to measure a humidify of the fuel/off gas mixture flowing through the portion of said fuel supply line, and wherein said controller controls the flow rate of the off-gas to be recirculated as a function of the humidity, as measured by said humidify sensor, to achieve an amount of moisture required to be added to the fuel cell.

4. A fuel supply system as set forth in clean 1, further comprising a humidify sensor which is installed in Ed off-gas recirculating line and works to measure a humidify of the off-gas flowing through said off-gas recirculating line, and wherein said controller controls the flow rate of the off-gas to be recirculated as a function of the humidify, as measured by said humidify sensor, to achieve an amount of moisture required to be added to the fuel cell.

5. A fuel supply system as set forth in claim 1, further comprising a temperature sensor which is installed in said off-gas recirculating line and works to measure a temperature of the off-gas flowing through said off-gas recirculating line, and wherein said controller controls the flow rate of the off-gas to be recirculated as a function of the temperature, as measured by said temperature sensor, to achieve an amount of moisture required to be added to the fuel.

6. A fuel supply system as set forth in claim 1, further comprising a hydrogen concentration sensor which is installed in a portion of said fuel supply line located downstream of said ejector device and works to measure a concentration of hydrogen contained in the fuel/off gas mixture flowing through the portion of said fuel supply line, and wherein said controller controls the flow rate of the off-gas to be recirculated as a function of the concentration of hydrogen, as measured by said hydrogen concentration sensor, to achieve a hydrogen stoichiometric flow ratio required by the fuel cell.

7. A fuel supply system as set forth in claim 1, further comprising a hydrogen concentration sensor which is installed in said off-gas recirculating line and works to measure a concentration of hydrogen contained in the off-gas, and wherein said controller controls the flow rate of the off-gas to be recirculated as a function of the concentration of hydrogen, as measured by said hydrogen concentration sensor, to achieve a hydrogen stoichiometric flow ratio required by the fuel cell.
